(19) United States
(12) Patent Application Publication
(10) Pub. No.: US 2007/0285269 A1
(43) Pub. Date: Dec. 13, 2007

(54) Device against bottoming-out of a flexible support

(75) Inventor: Pierre Geay, Nimes (FR)

Correspondence Address: John S. Egbert;Egbert Law Offices, 7th Floor, 412 Main Street, Houston, TX, 77002, US

(73) Assignee: WINNCARE INTERNATIONAL, Societe par actions simplifiee, Nimes (FR)

(21) Appl. No.: 11/449,035

(22) Filed: Jun. 7, 2006

(51) Int. Cl. G08B 21/00

(52) U.S. Cl. 340/686.1

(57) ABSTRACT

Device against bottoming-out of a flexible support such as a cushion, mattress or the like, includes an upper side and a lower side. The flexible support includes, internally, at least a mechanism permitting the evaluation of the distance separating the upper and lower sides, associated to a device capable of delivering a signal when the distance reaches a threshold value.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The object of this invention is a device against bottoming-out of a flexible support such as a cushion, mattress or the like, and in particular a device permitting to anticipate a risk of bottoming-out.

Such a device is in particular designed to equip the flexible supports, made of foam rubber or inflatable, and designed to receive a patient's body, such as, for example, a cushion or a mattress for the prevention and treatment of bedsores, used and conceived in view of preventing risks of bottoming-out, i.e. risks of contact of the body of said patient with the hardest portion of the support or the base on which rests said support.

### BACKGROUND OF THE INVENTION

It is known that persons constrained, for medical or physical reasons, to remain for a long period in certain position, seated or bedridden, for example, are likely to develop necroses of the skin at particular spots of the body at the level of which the body rests and where blood circulation is reduced and even interrupted.

In order to cope with these disadvantages, it is known that one should widen the contact surface of the body of the patient with the support, which can be achieved, in particular, with inflatable supports, such as mattresses or the like, having an adequate inflation pressure.

For inflatable supports, because of the different morphology of patients as well as of the unevenness of the distribution of their mass, it is necessary to adapt the inflation pressure according to the characteristics of the user, so that, on the one hand, the pressure is not too high to achieve the greatest possible contact surface, between the body and the support, and, on the other hand, the depression does not exceed a certain threshold beyond which there is a risk of bottoming-out, i.e. risk of creation of a contact zone with the structure carrying the inflatable support.

In order to cope with this disadvantage, it is known to adapt the pressure and to verify the depression level by sliding a hand between the inflatable support and the body, a technique that remains uncertain and obviously disturbing for the patient.

In order to try to cope with this disadvantage, it has been proposed to equip the inflatable supports with manometers permitting to adapt the inflation pressure to the morphology of the user and more precisely to the weight and height of the latter by using tables, or the like, establishing correspondences.

However, body mass is distributed differently. Thus, for the same weight and height, optimal inflation pressure can be different.

Besides, a risk of bottoming-out cannot be prevented by increasing inflation pressure.

### BRIEF SUMMARY OF THE INVENTION

The object of this invention is to cope with the various disadvantages mentioned above by providing a device against bottoming-out of a flexible support such as a cushion, mattress or similar, and in particular a device permitting to anticipate a risk of bottoming-out of great reliability, yet of a simple design and easy utilization and, for inflatable supports, getting relieved of controlling inflation pressure.

According to the invention, the device against bottoming-out of a flexible support such as a cushion, mattress or similar, comprising an upper side and a lower side, is mainly characterized in that it includes, internally, at least means designed capable of permitting the evaluation of the distance separating said upper and lower sides, associated to means capable of delivering a signal when said distance reaches a threshold value.

The flexible support is designed to be placed, by its lower side, on a rigid or non-rigid structure, a bed base or the like for example, and to receive, on its upper side, an object or a body to be supported. In case of a depression of the flexible support, at one or several spots, according to a predetermined depth, a signal is emitted permitting to inform that it is necessary to correct the inflation pressure.

The predetermined depth corresponds to the threshold limit of bottoming-out. It can also correspond to a value greater than that constituting the limit of bottoming-out so as to permit to anticipate the bottoming-out, and thus not reach the latter.

According to an additional feature of the device according to the invention, it is associated to signal processing means, which are in turn capable of emitting an alert signal.

According to another additional feature of the device according to the invention, it includes several means each designed capable of permitting the evaluation of the distance separating the upper and lower sides, and each arranged at a predetermined location, each of said means being capable of delivering a distinct signal.

According to a particular embodiment of the device according to the invention, the means designed capable of permitting the evaluation of the distance separating the upper and lower sides consists of means capable of performing a measurement, associated to means for processing of the measurement performed.

According to an additional feature of the device according to the invention, the means capable of performing a measurement consists of emitting and receiving means arranged at right angles with respect to each other, one at the level of the upper side and the other one at the level of the lower side.

According to a particular embodiment of the device according to the invention, the means designed capable of permitting the evaluation of the distance separating the upper and lower sides consists of at least one deformable element capable of contributing to the emission of a signal starting from a certain level of deformation connected with the bringing closer of said sides.

According to a variant of this particular embodiment of the device according to the invention, in which the support is an inflatable support including at least one envelope comprising an upper wall, possibly dimpled, and a lower wall. The deformable element incorporates at least two distant conductive elements, capable of getting into contact with each other under the direct action of the bringing closer of said two upper and lower walls, in order to close a circuit and emit a signal.

According to another variant of this particular embodiment of the device according to the invention, the support is an inflatable support including at least one envelope comprising an upper wall, possibly dimpled, and a lower wall. The deformable element is made of an electrically conductive material, capable of being deformed under the action of the bringing closer of the upper and lower walls, until a deformation that can close the circuit is reached.

According to a preferred embodiment of this other variant of the device according to the invention, it includes a printed circuit linked to an electric connection and comprising at least two distant terminals, the latter being designed to cooperate with a deformable element made of an electrically conductive material separated from said terminals by a hollow intercalate element, made of an electrically insulating material. The deformable element is capable of being forced into said intercalate element under the displacement of the upper wall, in a direction of the lower wall, and capable of establishing a connection between said terminals starting from a certain level of displacement.

According to another variant of this particular embodiment of the device according to the invention, the support is an inflatable support including at least one envelope comprising an upper wall, possibly dimpled, and a lower wall. The deformable element consists of an inflated element, of a thickness relative to a distance threshold separating the two upper and lower walls, associated to means capable of measuring the internal pressure thereof and cooperating with comparator means permitting to emit the signal when it detects a variation of pressure indicative of a crushing of said inflated element.

According to a particular embodiment of the device according to the invention, the signal is a pneumatic, electromagnetic, or mechanic signal.

According to another embodiment of the device according to the invention, the signal is an electric signal.

According to an additional feature of the device according to the invention, the electric signal is conveyed through a printed circuit incorporated into a flexible support.

The device according to the invention, regardless of the contemplated embodiment, permits, for inflatable supports, to get entirely relieved of any measurement of the inflation pressure, which does not have to be measured, even during the inflation phase. Actually, during this inflation phase one can insufflate air in the inflatable element until there is no signal indicating a risk of bottoming-out.

One can also, and preferably, overinflate the inflatable support, deflate it until a signal is triggered, then re-inflate it with the necessary appropriate quantity of air.

It should be noted that the device according to the invention can, according to the discussed embodiment, be integrated into a cover designed to envelop a flexible support not including such device.

The advantages and the features of the device according to the invention will become more evident from the following description and referring to the attached drawing, which represents several non-restrictive embodiments thereof.

### BRIEF DESCRIPTION OF THE SEVERAL VIEWS OF THE DRAWINGS

FIG. 1 represents a partial exploded schematic and perspective view of a first embodiment of the device against bottoming-out of a flexible support according to the invention.

FIG. 2 represents a schematic view of a portion of the same device.

FIG. 3 represents a schematic view of a portion of the same device.

FIGS. 4a and 4b represent cross-sectional views of a portion of the same device in different utilization configurations.

FIG. 5 represents a partial perspective and sectional view of another embodiment of the device according to the invention.

FIG. 6 represents a partial schematic and cross-sectional view of another embodiment of the device according to the invention.

FIG. 7 represents another partial schematic and cross-sectional view of another embodiment of the device according to the invention.

### DETAILED DESCRIPTION OF THE INVENTION

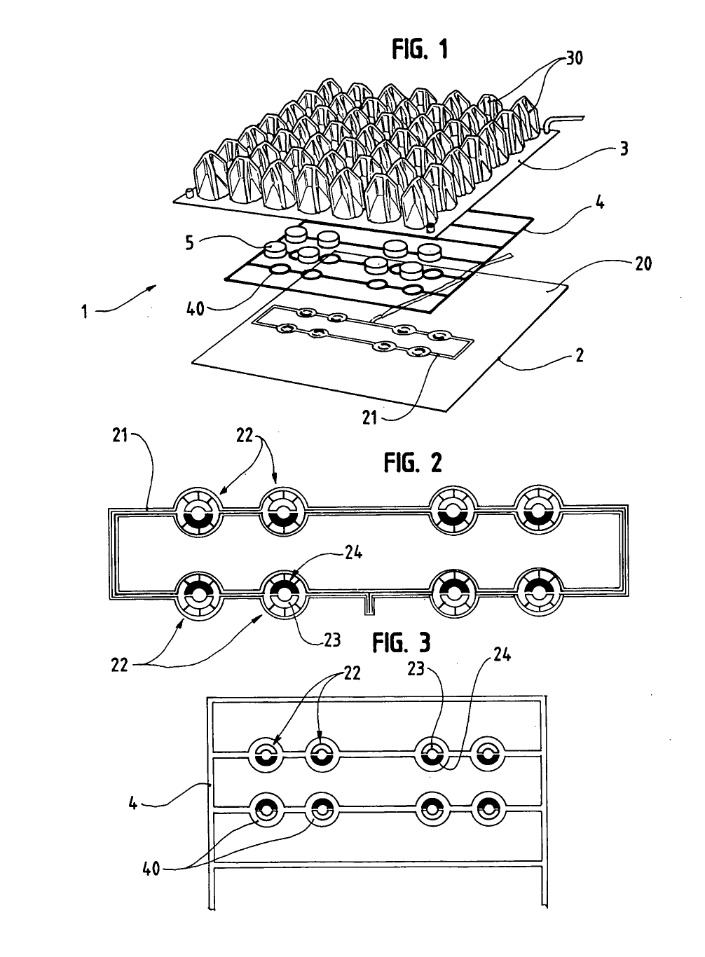

Referring to FIG. 1, one can see, according to the invention, a device against bottoming-out of an inflatable support 1, in which this inflatable support 1 comprises a lower wall or under-sheet 2 and an upper wall 3, the latter being comprised, in a known manner and not restrictively, of a juxtaposition of dimples 30.

It should be noted that the support is not limited to an alveolar structure as shown; it can be in other forms, such as a succession of tubes for example.

The under-sheet 2 includes on its face 20, internally with respect to the inflatable support 1, a printed circuit 21, also visible on FIG. 2, and which comprises a succession of pairs 22 of distant electrodes 23 and 24, which can consist, for example, of labels silk-screen printed by means of a conductive ink.

The printed circuit 21 and, more precisely, the pairs 22 of electrodes 23 and 24 are disposed at right angles with respect to the particular recesses, which correspond to the places likely to be bottomed out first.

Interposed between the under-sheet 2 and the upper wall 3 is a grid 4 formed of an electrically insulating material, and comprising elements 40 each in the shape of a ring or the like, including a central recess 41 aimed at being positioned at right angles with respect to a pair 22 of distant electrodes 23 and 24, as evident from FIG. 3.

It should be noted that in a particular embodiment, the printed circuit 21 is an integral part of the grid 4.

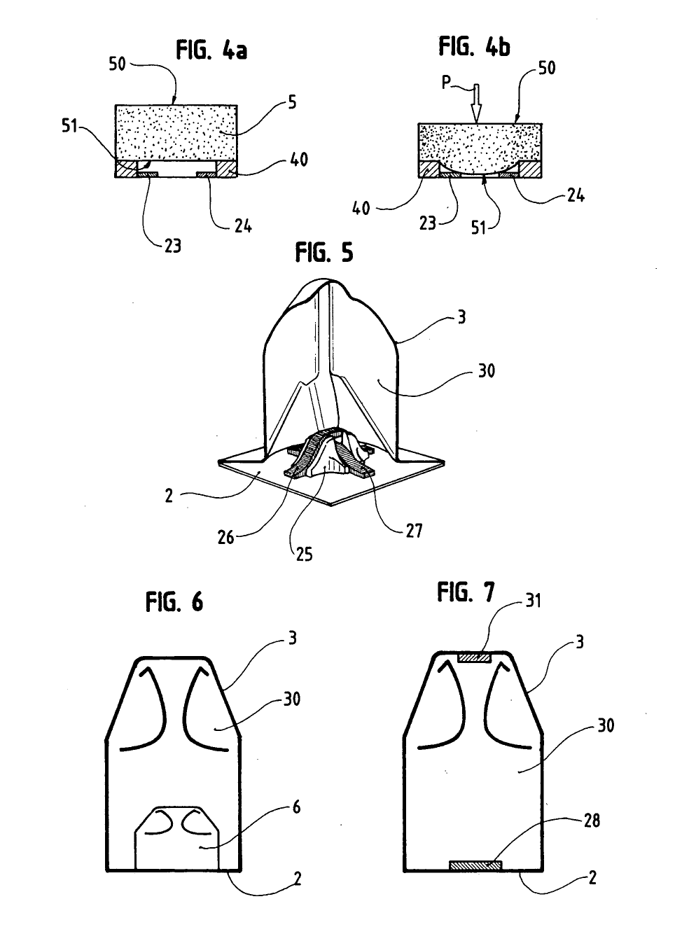

As also seen on FIG. 4a, each element 40 is crowned with a button 5, which is made of flexible and electrically conductive rubber foam, or of rubber foam associated to a conductive element such as a pellet for example.

Referring now to FIG. 4b, one can see that when the quantity of air in the envelope 1 is not sufficient, the upper wall 3, not shown, gets into contact with the upper face 50 of the button 5 and exerts thereon a pressure P, which can provoke the deformation of the button 5 and the driving of the latter inside the recess 41 of the element 40, until the connection, through its lower face 51, of the two electrodes 23 and 24, in order to finally obtain the closing of the circuit.

According to the nature and thickness of the rubber foam button 5, as well as to the dimensional characteristics of the element 40, a depression threshold is defined beyond which the electric circuit is closed, with, as a result, the emission of a signal, which can be processed in order, for example, to set off an alarm, or an automatic inflation.

Besides the fact that the device according to the invention permits to solve the problem raised, this embodiment has the advantage of being able to make a contact without creating any hard points on the body of the patient.

The printed circuit 21 can be more or less complex, i.e., for example, designed capable of permitting to mark out the position of the contact or contacts, thus allowing the localization of the risky zones.

Referring now to FIG. 5, one can see another embodiment of the device according to the invention. One notices again an inflatable support 1, a lower wall or under-sheet 2 and an upper wall 3 composed of a juxtaposition of recesses 30, of which only one is represented in this case.

In this embodiment, the lower wall or under-sheet 2 has a deformable portion 25 having a profile permitting to superpose, at a certain distance from each other, two electrodes 26 and 27, so that the depression of the recess 30, beyond a certain threshold, provokes the deformation of the portion 25 until the two electrodes 26 and 27 get in contact.

It should be noted that this embodiment permits to contemplate measurements of several thresholds at the same place.

It should also be noted that this embodiment can be applied to a support that is not inflatable, made of flexible rubber foam, for example, in which means are provided, such as a cavity for example, in order to permit the two electrodes to get into contact or not.

Referring now to FIG. 6, one can see another embodiment of the device according to the invention, in which is arranged at right angles with respect to the recess 30, a cell 6 inflated at a certain pressure and extending over a certain height between the lower wall or under-sheet 2, and the upper wall 3.

When the quantity of air in the inflatable element 1 is not sufficient, the upper wall 3 compresses the cell 6, and by measuring the internal pressure of the latter one can detect any risk of bottoming-out.

The cell 6 can be made integral either with the lower wall 2 or with the upper wall 3, but it can also be entirely free.

In this embodiment, the emitted signal can either be a signal of electric origin, or a signal of pneumatic origin.

Referring now to FIG. 7, one can see another embodiment of the device according to the invention, in which the lower wall 2 is provided with emitting means 28, and the upper wall 3 with receiving means 31, or vice versa.

The emitting 28 and receiving 31 means are capable of permitting to measure, with precision, if necessary, the distance separating them, so that, when this distance goes beyond a certain value, a signal can be emitted.

This embodiment can also be used for equipping supports made of flexible rubber foam, the emitting and receiving means being placed internally, under the surface of the upper side and under the surface of the lower side.

I claim:

1. Device against reaching bottoming-out, comprising:
a flexible support being comprised of an upper side and a lower side;
a means for permitting evaluation of a distance separating said upper side and said lower side, being located internally in said flexible support; and
a means for delivering a signal when said distance reaches a threshold value, said means for delivering being associated with said means for permitting evaluation.

2. Device against bottoming-out according to claim 1, further comprising:
a signal processing means, emitting an alert signal.

3. Device against bottoming-out according to claim 1, wherein said means for permitting the evaluation of the distance separating the upper and lower sides are disposed in a predetermined place, each of said means delivering a distinct signal.

4. Device against bottoming-out according to claim 1, wherein said means for permitting the evaluation of the distance separating the upper and lower sides is comprised of means for performing a measurement, and a means for processing the measurement performed.

5. Device against bottoming-out according to claim 4, wherein said means for performing a measurement is comprised of emitting and receiving means arranged at right angles with respect to each other, one at a level of the upper side and the other at the level of the lower side.

6. Device against bottoming-out according to claim 1, wherein said means for permitting the evaluation of the distance separating the upper and lower sides is comprised of at least one deformable element, contributing to delivery of a signal starting from a certain level of deformation connected with bringing closer of the sides.

7. Device against bottoming-out according to claim 6, wherein said flexible support is an inflatable support being comprised of at least one envelope, comprising an upper wall, being dimpled, and a lower wall, and wherein said deformable element incorporates at least two distant conductive elements, capable of getting into contact with each other under direct action of bringing closer of said two upper and lower walls, in order to close a circuit and to emit a signal.

8. Device against bottoming-out according to claim 6, wherein said flexible support is an inflatable support being comprised of at least one envelope, comprising an upper wall, being dimpled, and a lower wall, and wherein said deformable element is comprised of an electrically conductive material, being deformed under action of the bringing closer of the upper and lower walls, until a deformation to close a circuit is reached.

9. Device against bottoming-out according to claim 8, further comprising:
a printed circuit being linked to an electric connection and comprising at least two distant terminals, the distant terminals cooperating with a deformable element comprised of an electrically conductive material separated from the terminals by a hollow intercalate element, said intercalate element being comprised of an electrically insulating material, said deformable element being forced into said intercalate element under displacement of the upper wall, in a direction of the lower wall, and
a means of establishing a connection between said terminals starting from a certain level of displacement.

10. Device against bottoming-out according to claim 6, wherein said flexible support is an inflatable support comprising at least one envelope, comprising an upper wall, being dimpled, and a lower wall, and wherein said deformable element is comprised of an inflated element, having a thickness relative to a distance threshold separating the two upper and lower walls, and further comprising:
means for measuring internal pressure thereof and cooperating with a comparing means permitting to emit a signal when detecting a variation of pressure indicative of a crushing of said deformable element.

11. Device against bottoming-out according to claim 1, wherein said signal is a pneumatic, electromagnetic, or mechanic signal.

12. Device against bottoming-out according to claim 1, wherein said signal is an electric signal.

13. Device against bottoming-out according to claim 12, wherein the electric signal is conveyed through a printed circuit incorporated into the flexible support.
